(19) United States
(12) Patent Application Publication
(10) Pub. No.: US 2005/0071309 A1
(43) Pub. Date: Mar. 31, 2005

(54) Computing environment adapted to transfer software or data from a file system to a workstation

(76) Inventor: Eric Ustaris, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/672,955

(22) Filed: Sep. 26, 2003

(51) Int. Cl. G06F 7/00

(52) U.S. Cl. 707/1

(57) ABSTRACT

A computing environment comprises a file server, a file system adapted to store software and data and that is adapted to be accessible to the file server and a workstation adapted to couple to the file server and to a client computer. The workstation may be adapted to cause at least some software or data that is not permanently stored on the workstation to be transferred to the workstation from the file system via the file server when requested by the client computer.

### BACKGROUND

Some systems in an organization may be mission critical. For example, a web server that allows online ordering may be significant to an organization's revenue model. Customers and employees associated with an organization may demand that these systems be available and operational a vast majority of the day and night. The demand for high availability of a system may increase operational costs to the organization. For example, information technology staff may need to be employed to monitor the critical system 24 hours a day in order to fix the system in case of failure.

### SUMMARY

In some embodiments, a computing environment comprises a file server, a file system adapted to store software and data and that is adapted to be accessible to the file server and a workstation adapted to couple to the file server and to a client computer. The workstation may be adapted to cause at least some software or data that is not permanently stored on the workstation to be transferred to the workstation from the file system via the file server when requested by the client computer.

### BRIEF DESCRIPTION OF THE DRAWINGS

For a detailed description of embodiments of the invention, reference will now be made to the accompanying drawings in which:

FIG. 1 shows a computing environment in accordance with various embodiments of the invention; and

FIG. 2 shows an exemplary layout of server components in accordance with the computing environment of FIG. 1.

### NOTATION AND NOMENCLATURE

Certain terms are used throughout the following description. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

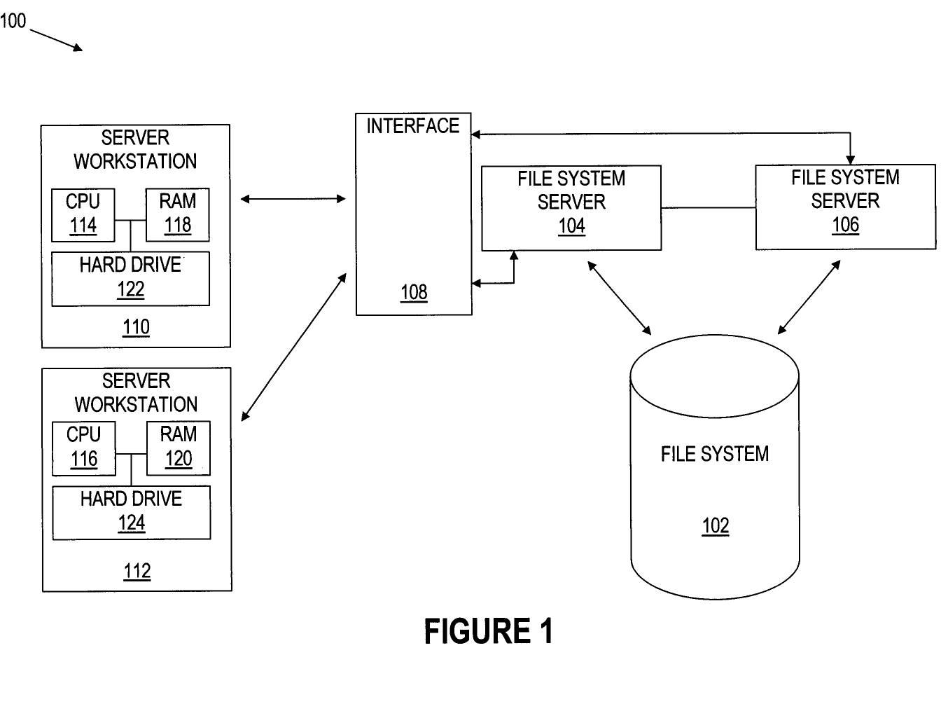

Referring now to FIG. 1, a computing environment 100 comprising a file system 102 coupled to one or more file servers 104 and 106. The file system 102 may store data in accordance with one or more file protocols, such as Network File System (“NFS”) and Andrew File System (“AFS”). To access the data stored in the file system 102, the file system servers 104 and 106 store and retrieve data according to the one or more file protocols employed on the file servers 104 and 106.

The file system 102 may comprise one or more non-volatile storage devices, such as hard drives and tape drives, that may be configured in a redundant fashion. For example, multiple hard drives may contain identical copies of data so that if one of the drives fails, the other drive(s) may continue to host the data. Thus, the file system 102 is not prone to failing if a single software or hardware failure occurs within the system. A Redundant Array of Inexpensive Disks (“RAID”) configuration is an additional example of a configuration suitable for the file system 102.

The RAID and other redundant storage mechanisms may implement “striping,” a method of concatenating multiple drives into one logical storage unit. Striping involves partitioning each drive's storage space into stripes that may be any suitable size, such as one sector (512 bytes) or several megabytes. The stripes are then interleaved in a round-robin fashion on the array of disks so that if one drive fails, a redundant drive may be used to retrieve the desired data.

In alternative embodiments, the file system 102 may comprise a centralized database that may have multiple access ports through which connections to exchange data may be established. In such embodiments, the file system servers 104 and 106 may comprise database servers.

An interface 108 may permit data exchange between the file system servers 104 and 106 and one or more server workstations 110 and 112. In the configuration shown in FIG. 1, the file servers 104 and 106 and the file system 102 are external to the server workstations 110 and 112. The file system servers 104 and 106 preferably operate as a redundant “cluster,” thereby limiting the risk that a hardware failure to any one file system servers 104 or 106 will cause the file system 102 to be unavailable. A cluster is group of one or more system working in conjunction to perform a common task. In the case of file system server 104 and 106, the common task may be to facilitate the exchange of data between file system 102 and the workstation 110 and 112. In some embodiments, the file system servers 104 and 106 may be capable of balancing the load of data requests from the server workstations 110 and 112, thereby minimizing the overall load placed on any one file system server 104 or 106. In other embodiments, the file system servers 104 and 106 may employ a “heartbeat” algorithm to maintain availability of the file system 100. The heartbeat algorithm may provide the various functions required by a file server, such as starting and stopping resources, monitoring the availability of the systems in the cluster, and transferring ownership of a shared internet protocol (“IP”) address between the high available file system servers 104 and 106.

The server workstations 110 and 112 may comprise workstations with sufficient resources and configurations to handle any anticipated traffic through the computing environment 100. Each server workstations 110 and 112 may have an instance of an operating system, such as Windows NT or HPUX, and any other software that facilities the communication between server workstations 110 and 112 and the interface 108. For example, SAMBA, a Windows-based fileserver, may facilitate seamless file and print services between a Network File System (“NFS”) employed on the file system 102 and a Windows server workstation 110 or 112. The HPUX operating system may have the capability to interact with the NFS built-in.

The server workstations 110 and 112 may be configured with one or more central processing units (“CPUs”), random access memory units (“RAMs”), and hard drives. An exemplary configuration, as shown in FIG. 1, may include CPUs 114 and 116, RAMs 118 and 120, and hard drives 122 and 124 configured in server workstations 110 and 112, respectively. Additional components and hardware configurations may be possible as well. In addition, the workstations 110 and 112 may employ various load balancing mechanisms to reroute and distribute traffic evenly among the server workstations 110 and 112.

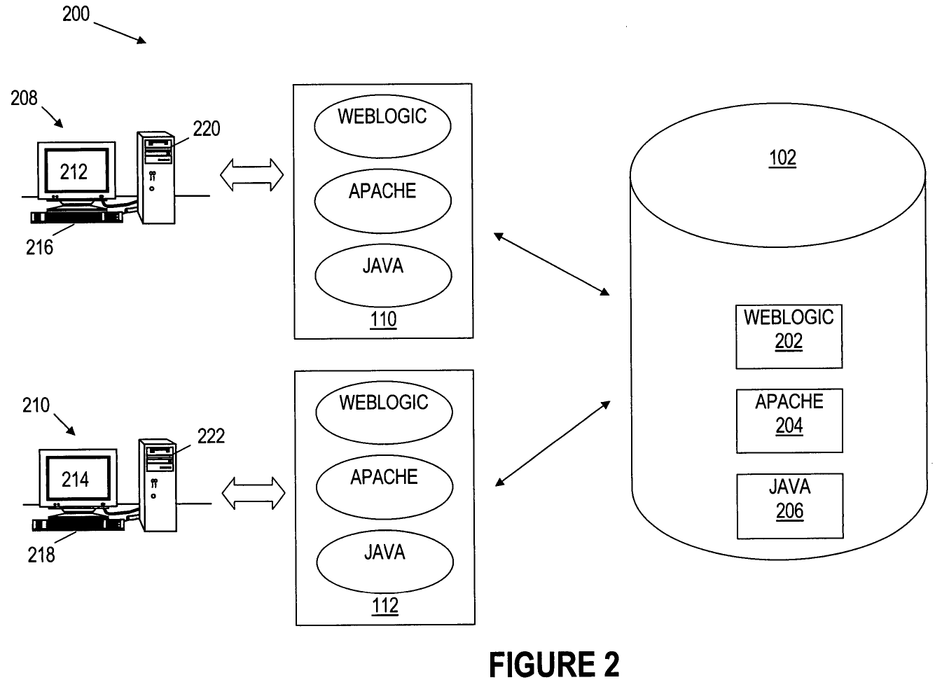

Referring now to FIG. 2, an exemplary layout 200 of server components is shown in accordance with the various embodiments of the invention. The program files associated with server processes (e.g., Apache, Weblogic, Tomcat) or other software components (e.g., Java, PHP, CVS) may be stored on the file system 102. Although any number of server or software components may be included, the exemplary layout 200 includes three components, Weblogic 202, Apache 204, and Java 206, that are stored in the file system 102 as shown.

The Weblogic component 202 may be a Java server application capable of handling multiple requests simultaneously. In addition, the Weblogic component 202 may have a built-in load balancing mechanism and a web-hosting feature.

The Apache component 204 may be an open source web server. Supported by the Apache component 204 may be various external programming protocols, such as common gateway interface (“CGI”), Perl, and active server Pages (“ASP”). The apache component 202 also may have a built-in load balancing mechanism.

The Java component 206 is a developmental runtime programming language. Various runtime libraries, dynamic link libraries, and executable programs may be included in the Java component 206. The Java component 206 may facilitate the execution of Java code on the server workstations 110 and 112.

In addition to the software and server components, data utilized by the server workstations 110 and 112 may also be stored in the file system 102. The data may comprise web pages hosted by the Apache component 204, java server pages (“JSPs”) hosted by the Weblogic component 202, and other data files utilized by a software or sever component.

Because the server, software components, and associated data may be stored on the file system 102, the workstations 110 and 112 retrieve the necessary program and configuration files through the interface 108 (FIG. 1). After retrieval, the server workstations 110 and 112 may load one or more of the components, Weblogic 202, Apache 204, and Java 206, into the RAM 118 and 120, respectively. Once loaded into the RAMs 118 and 120, the server and software components may use the other resources associated with the workstations 110 and 112, such as CPUs 114 and 116 and disk drives 122 and 124, to operate the one or more components. For example, access and error logs generated by the Apache component 204 may be stored on disk drive 122 while the Weblogic kernel associated with the Weblogic component 202 is being executed by the CPU 114. In alternative embodiments, the server and software components may also use the file system 102 to store operational files, such as access logs, error logs, and configuration settings.

Referring again to FIG. 2, once the desired server, software components, and associated data are loaded onto the server workstations 110 and 112, clients 208 and 210 may establish connections to the server workstations 110 and 112 for utilizing the services associated with the server and software components. Although any number of clients may establish connections to the workstations 110 and 112, two clients 208 and 210 are shown in the exemplary layout 200. Each client 208 and 210 may include a display device 212 and 214, a keyboard 216 and 218, and processing logic 220 and 222, respectively. The processing logic 220 and 222 may comprise additional components, such as a central processing unit (“CPU”), a display adapter, and non-volatile memory, as desired.

The clients 208 and 210 may be “thin” or “thick” clients. Thin clients may have only presentation logic, such as a web browser, executed locally, whereas thick clients may have presentation and “business” logic executed locally. The business logic may comprise the processing required on data sent from a client to a server.

In addition, although all three software and server components, Weblogic 202, Apache 204, and Java 206, are shown as loaded on the server workstations 110 and 112, any or all components stored on the file system 102 may loaded on to the workstations 110 and 112 as desired.

The resulting computing environment 100 generally represents a cost effective and flexible solution to producing a highly available data and server system. If a server workstation 110 or 112 fails, a new workstation may replace the failed workstation. In addition and in accordance with exemplary embodiments of the invention, because the program executables and other associated data are stored on the file system 102, the new workstation may only need minimal configurations. In some embodiments, only an operating system installation, as well as a minimal configuration of the desired server and software components that are stored on the file system 102, is needed to create the computing environment 100.

Additional workstations also may be employed to increase the scalability of the computing environment 100. For example, instead of the two workstations 110 and 112, three or more workstations may be configured to access the file system 102 through the interface 108. Each workstation may load particular server and software components that are stored on the file system 102 as desired.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A computing environment comprising:
a file server;
a file system adapted to store software and data and that is adapted to be accessible to the file server; and
a workstation adapted to couple to the file server and to a client computer;
wherein the workstation is adapted to cause at least some software or data that is not permanently stored on the workstation to be transferred to the workstation from the file system via the file server when requested by the client computer.

2. The computing environment of claim 1 wherein the file system comprises a centralized database.

3. The computing environment of claim 1 wherein the file server comprises a database server.

4. The computing environment of claim 1 further comprising a plurality of file servers that implement load balancing to distribute traffic among the file servers.

5. The computing environment of claim 1 wherein the file server implements a heartbeat that determines whether the file server has failed.

6. The computing environment of claim 1 wherein the file system implements a file protocol selected from the group consisting of Network File System (“NFS”), Andrew File System (“AFS”), and a combination of NFS and AFS.

7. A computing environment comprising:
a file server;
a file system that is adapted to store client applications and data and that is adapted to be accessible to the file server; and
a workstation adapted to couple to the file server and to a client computer, the workstation comprises a storage medium on which control files are permanently stored, but client applications are not permanently stored;
wherein the workstation is adapted to cause client applications and data to be transferred to the workstation from the file system via the file server when requested by the client computer.

8. The computing environment of claim 7 wherein the data that is transferred to the workstation is used by a client application running on the workstation and wherein the data is permanently stored on the file system and not the workstation.

9. The computing environment of claim 7 wherein control files comprise server configuration settings.

10. The computing environment of claim 7 further comprising an interface through which the file server communicates to the workstation.

11. The computing environment of claim 7 wherein the file system comprises a storage medium selected from the group consisting of Redundant Arrays of Inexpensive Disks (“RAID”) and small computer system interface (“SCSI”) drives.

12. A method implemented on a system comprising a file server coupled to a workstation, a client computer and a file system, comprising:
receiving a request from a client computer for a client application, the client application being stored in non-volatile memory on the file system and not on the workstation;
transferring the requested client application from the file system to the workstation for execution on the workstation; and
executing the requested client application on the workstation.

13. The method of claim 12 further comprising receiving a request from the client computer for data to be used by the client application, the data being stored permanently in non-volatile memory on the file system and not in non-volatile memory on the workstation.

14. The method of claim 13 further comprising transferring the requested data from the file system to the workstation.

15. A system, comprising:
a file server;
means for storing client applications and data; and
means for retrieving the client applications and data from the means for storing the client applications and data and for executing the client applications as required by a client computer.

16. The system of claim 15 wherein the means for retrieving further comprises means for retrieving the client applications and data from the means for storing each time a client computer requires execution of the client applications.

17. A workstation, comprising:
a CPU; and
a volatile memory coupled to the CPU;
wherein said CPU requests a client application and data from an external file system on behalf of a client and executes the client application on behalf of the client.

18. The workstation of claim 17 wherein the workstation requests a client application and data from the external file system every time a client requests the client application to be executed.
